(19) United States
(12) Patent Application Publication
(10) Pub. No.: US 2007/0244865 A1
(43) Pub. Date: Oct. 18, 2007

(54) Method and system for data retrieval using a product information search engine

(75) Inventors: Justin Harding Gordon, San Francisco, CA (US); Maobing Jin, San Jose, CA (US); Kamran Karim Kundi, Foster City, CA (US); Wolfgang Mathurin, San Francisco, CA (US); Patrice Pominville, Brisbane, CA (US); Didier Prophete, San Francisco, CA (US); Patrick Siu-Nang See, San Jose, CA (US)

Correspondence Address: DUKE W. YEE, P.O. BOX 802333, YEE & ASSOCIATES, P.C., DALLAS, TX, 75380, US

(73) Assignee: International Business Machines Corporation, Armonk, NY (US)

(21) Appl. No.: 11/406,223

(22) Filed: Apr. 17, 2006

(51) Int. Cl. G06F 17/30

(52) U.S. Cl. 707/3

(57) ABSTRACT

A system for searching for data in a database. A query search is received in a query language using objects. The query search includes a number of objects having attributes. A set of hybrid query instructions is generated using the number of objects having attributes for searching relational and hierarchical data in the database. In response to generating the set of hybrid query instructions recognized by the database for searching data, the set of hybrid instructions are executed to obtain a result from the database.

### BACKGROUND OF THE INVENTION

1. Field of the Invention

The present invention relates generally to an improved data processing system. More specifically, the present invention is directed to a computer implemented method, apparatus, and computer usable program code to retrieve product information data using a product information search engine.

2. Description of the Related Art

Currently, a variety of data are stored in databases. These databases, which include many different categories and types of information, make data available for retrieval by users as needed. While some databases are relatively simple in use and application, the nature and amount of data contained within a database may be quite extensive and complex. As a result, querying complex interrelated data may be substantially more difficult and complicated if truly usable information is going to be retrieved from a database containing such complex data.

A user employs a query language to retrieve desired data from a database. The word query means to interrogate a collection of data, such as, for example, records in a database. Query languages define the syntax that a user must utilize to communicate with a database. The query language determines which data is manipulated or retrieved within the database. Two commonly used query languages are structured query language (SQL) and object-oriented query language.

Within the various specialized fields of database and query language programming, relational database systems and hierarchical database systems are widely used. A relational database may be seen as a collection of tables that contain aggregated data about different entities. A hierarchical database may be seen as an organizational chart that links records in a hierarchy from a top root node down to bottom terminal nodes. Usually, the data within a relational database is indexed, whereas data within a hierarchical database is non-indexed. Also, a relational database typically needs an SQL query search engine to retrieve data, whereas a hierarchical database usually requires a specific query search engine to retrieve data. Consequently, querying a complex database that contains both relational and hierarchical data with a standard SQL or specific search engine may not retrieve complete or accurate information.

A product information management system may employ such a complex database that includes a very unique data structure of highly interconnected referential and hierarchical product information. An enterprise may use the product information management system to assemble an accurate, consistent central repository of product information, which may otherwise be scattered throughout the enterprise's other systems. The data within the complex database may include, for example, product name, type, description, price, picture, location, trading partner, shipping information, terms of trade information, and the like. Some product information may be localized, that is, the information about the same item may differ from region to region or from one branch to another branch. Searching such a unique and complex graph of product information through a standard query language search engine may be cumbersome and difficult for the user.

Thus, it would be beneficial to have a computer implemented method, apparatus, and computer usable program code to provide a simple, user-friendly product information search engine to retrieve relational and hierarchical product information data within high quality product information management systems.

### SUMMARY OF THE INVENTION

The present invention provides a computer implemented method, apparatus, and computer useable program code for searching for data in a database. A query search is received in a query language using objects. The query search includes a number of objects having attributes. A set of hybrid query instructions is generated using the number of objects having attributes for searching relational and hierarchical data in the database. In response to generating the set of hybrid query instructions recognized by the database for searching data, the set of hybrid instructions are executed to obtain a result from the database.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing system in which aspects of the present invention may be implemented;

FIG. 2 is a block diagram of a data processing system in which aspects of the present invention may be implemented;

FIG. 3 is a block diagram illustrating components of a server used for product information data retrieval from a product information management system in accordance with an embodiment of the present invention;

FIG. 4 is a pictorial illustration of an exemplary window for inputting product information query search criteria in accordance with an embodiment of the present invention;

FIG. 5 is a pictorial illustration of an exemplary window for creating a product information query search template in accordance with an embodiment of the present invention;

FIG. 6 is an exemplary illustration of an object model in a product information management domain specific query language in accordance with an embodiment of the present invention;

FIG. 7 is a flowchart illustrating an exemplary process for a server device to retrieve product information data in accordance with an embodiment of the present invention;

FIG. 8 is a flowchart illustrating an exemplary process for a client device to request product information data retrieval in accordance with an embodiment of the present invention; and

FIG. 9 is an exemplary query script operation in accordance with an embodiment of the present invention.

### DETAILED DESCRIPTION OF THE PREFERRED EMBODIMENT

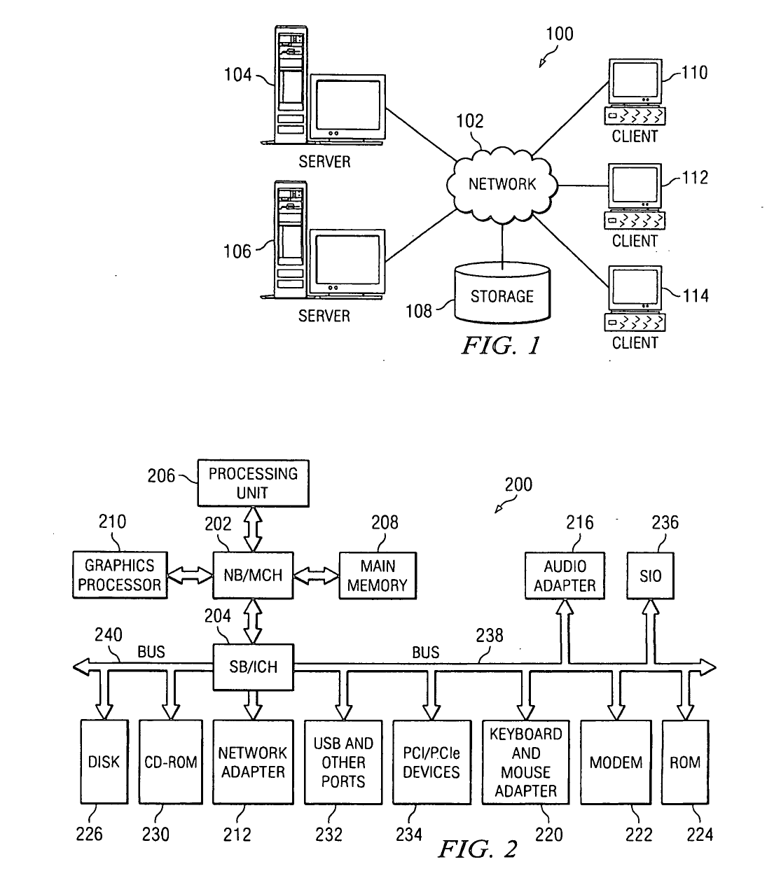

With reference now to the figures and in particular with reference to FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 also connect to network 102. Clients 110, 112, and 114 may be, for example, personal computers or network computers. In this depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to north bridge and memory controller hub 202. Processing unit 206 contains a set of one or more processors. When more than one processor is present, these processors may be separate processors in separate packages. Alternatively, the processors may be multiple cores in a package. Further, the processors may be multiple multi-core units.

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeriese® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Aspects of the present invention provide a computer implemented method, apparatus, and computer usable program code for retrieving product information data in a data processing system. However, it should be noted that although in this illustrative example product information management system data is retrieved, other types of data may be retrieved or queried. The data processing system uses a search engine within a product information management system to retrieve the product information data. The product information management system may reside, for example, in a server within the data processing system. The product information data is information contained in a database and/or memory of the data processing system with regard to products and/or services provided by an enterprise utilizing the product information management system.

In response to receiving a product query search to retrieve product data, the search engine generates a set of hybrid query instructions using a product information management domain specific query language for searching relational and hierarchical product information data. A domain specific language is created specifically to solve problems in a particular domain and is not intended to solve problems outside of the particular domain the language is created for. For example, in this illustration, the domain is a product information management system and the product information management domain specific query language used to generate the set of hybrid query instructions is only utilized within the product information management system. Hence, a hybrid query instruction is generated by the search engine by creating an abstract syntax tree from a user created query search or statement. The hybrid query instruction is stored within the abstract syntax tree. The hybrid query instruction is able to search indexed and non-indexed data within a data repository, such as a database and/or memory, using a hybrid of structured query language and object-oriented query language to return a combined result of both the indexed and non-indexed data searches. During hybrid query instruction generation, the search engine populates the abstract syntax tree with different indexed and non-indexed data using visitor pattern. The data populating the abstract syntax tree are specific object attributes, which include indexed and non-indexed attributes, stored in the nodes of the abstract syntax tree. These indexed and non-indexed attributes stored in the abstract syntax tree determine what actions the search engine takes with regard to the query search, such as performing the structured query language search of the indexed attributes first and then if non-indexed attributes are discovered after performing the structured query language search an object-oriented query language search is performed for the non-indexed attributes. However, it should be noted that although an abstract syntax tree is used in this illustrative example, other types of data structures or abstractions may be utilized to maintain the relationships between the objects and the object's attributes. In addition, the set of hybrid query instructions may be zero, one, or more hybrid query instructions.

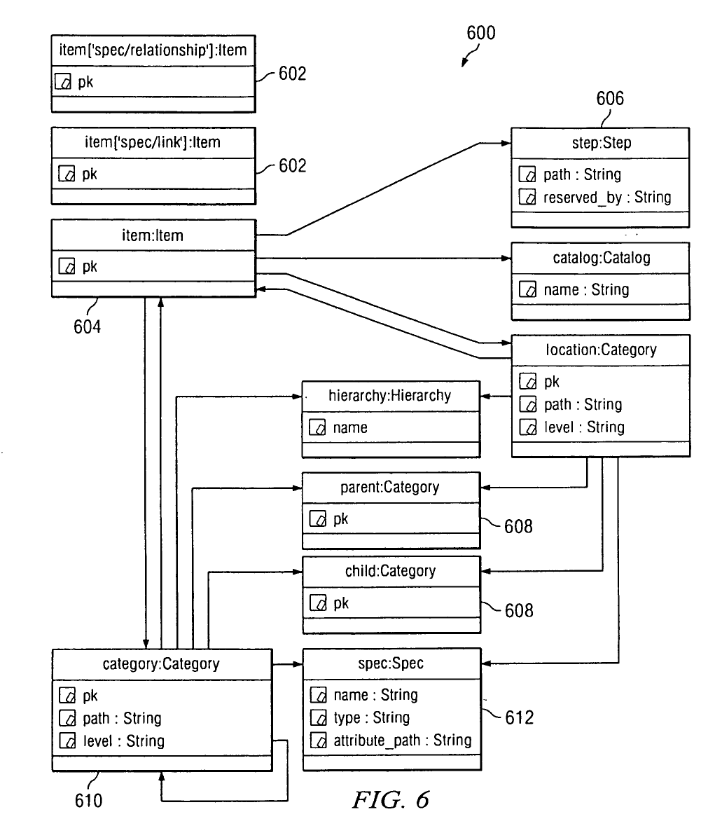

The product information management domain specific query language is a hybrid query language that includes both structured query language and object-oriented query language. In addition, the product information management domain specific language defines product information management objects. The objects may be, for example, item, category, catalog, hierarchy, location, spec, and step. These objects all hold data. The data, to be more specific, are object attributes. In other words, the attributes are part of the object. The object attributes may be, for example, an object join or member data. Examples of an object join using dot notation may be, for example, item.category and item.catalog, which are illustrated in FIG. 6 below. All object attributes are leaf nodes, or terminal attributes, in an abstract syntax tree created by a syntax parser in the search engine from the product query search. Subsequent to generating the set of hybrid query instructions, the search engine searches indexed and non-indexed product information data within the data processing system. Then, in response to retrieving the desired product information data, the search engine returns a result set to, for example, a client device, which requested the product information query search. The returned result set is the product information data desired by a user from the product information management system. The result set may be zero, one, or more product information data.

Using aspects of the present invention, a user, such as, for example, an application developer, administrator, or end user, may interact with and query indexed, as well as non-indexed, product information data contained within a product information management system without understanding the complexities of the product information management system's data model. Thus, aspects of the present invention allows an end user to quickly and effectively find product information by performing a query search operation against complicated product data through a relational structured query language based search and/or a hierarchical Java™ serialized based search. This query search operation is made possible by augmenting metadata of relational databases with domain specific language of the product information management system.

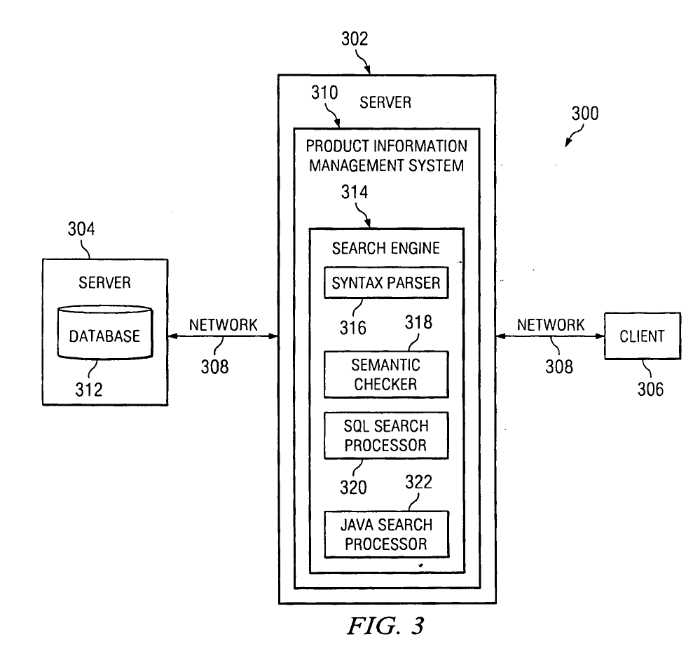

Referring now to FIG. 3, a block diagram illustrating components of a server used for product information data retrieval from a product information management system is depicted in accordance with an embodiment of the present invention. Distributed data processing system 300 may include server 302, server 304, and client 306, which are coupled together by network 308. For example, network data processing system 100 contains server 104, server 106, and client 110 that are connected together by network 102 in FIG. 1.

Server 302 may include product information management system 310, and server 304 may include database 312. Even though product information management system 308 is depicted within server 302, embodiments of the present invention are not restricted to such. For example, product information management system 310 may reside in another client device, such as, for example, client 112 in FIG. 1. In addition, even though database 312 is shown within server 304, embodiments of the present invention are not restricted to such either. For example, database 312 may be located in a separate storage unit, such as storage 108 in FIG. 1, or in server 302.

Product information management system 310 is a software application designed to manage an enterprise's product information in a central repository. A user utilizing client 306 may access product information management system 310 to manipulate or retrieve desired product information data. Product information management system 310 may use database 312 to store the enterprise's product information. Database 312 may, for example, represent a plurality of databases and/or memory, such as main memory 208 and ROM 224 in FIG. 2, or any combination thereof.

Database 312 is able to store product information in two primary forms. One form is structured or indexed data and the other is semi-structured or non-indexed data. As discussed previously above, querying both indexed and non-indexed data within database 312 using a standard search engine may not produce the desired product information result. Consequently, embodiments of the present invention implement a unique search engine, such as search engine 314, to perform a search of indexed and non-indexed data within database 312. Search engine 314 resides in product information management system 310. Further, search engine 314 may include, for example, syntax parser 316, semantic checker 318, SQL search processor 320, and Java™ search processor 322.

Product information management system 310 utilizes search engine 314 to execute a product query search sent, for example, from client 306, parse the product query search, generate a set of hybrid query instructions, execute the set of hybrid query instructions, and return a result set to client 306. The product information management domain specific query language adopts the SQL syntax and defines a list of data objects in the product information management domain specific query language so that the product information management domain specific query language includes both an SQL based query language and an object-oriented based query language. These data objects are built in the product information management domain specific language and are used to generate hybrid query instructions. Examples of these data objects may be, for example, item, category, catalog, hierarchy, location, spec, and step. These object examples are illustrated in FIG. 6. Syntax is the set of rules that govern the structure of the query language.

Subsequent to receiving the product query search string from client 306, search engine 314 parses the query string and performs syntax analysis. Parsing means to breakdown the query string into the query string's functional units. Search engine 314 utilizes syntax parser 316 to parse the query string. Search engine 314 uses the parsed query string to generate an abstract syntax tree. An abstract syntax tree is a finite, labeled, directed tree, where operators label the internal nodes and the leaf nodes represent the operands of the node operators. An operator performs an operation and an operand references data.

In addition to parsing the query string, syntax parser 316 also performs the syntax analysis of the query string. Syntax parser 316 analyzes the query string to make sure that the query string adheres to each syntax rule. If syntax parser 316 determines that the query string violates the syntax rules, then an error message is sent to client 306. For example, a query search string, such as new SearchQuery string, may throw a parsing exception with the following error message: ‘Invalid search query:<SearchQuery string>-<error details>’.

After generating the abstract syntax tree and analyzing the query for syntax error, search engine 314 performs a semantic check over the abstract syntax tree. Search engine 314 employs semantic checker 318 to perform the semantic check. If semantic checker 318 determines that the query violates any semantic rule, then an error message is sent to client 306. For example, the query may throw a search unsupported exception with the following error message:‘Unsupported attribute and/or predicate in query:<SearchQuery string>-<error details>’.

After performing the semantic check over the abstract syntax tree, search engine 314 generates the hybrid query instructions. Hybrid query instruction generation may include several steps, such as, for example, data population of the abstract syntax tree, attribute analysis, and hybrid query instruction generation. An attribute represents a single element of a product information data object. During attribute analysis, the abstract syntax tree is traversed to collect all attribute data. The goal of attribute analysis is to create a map between the product query search path and the target data. The query attribute path is a sequence or list of terminal attribute nodes in the abstract syntax tree. Embodiments of the present invention may use, for example, named attributes and spec-driven attributes as terminal attribute nodes. For example, the query attribute node “item.category [‘spec/xyz’]” includes three terminal attribute nodes: the named attribute node ‘item’ the named attribute node ‘category’ and the spec-driven attribute node ‘[spec/xyz]’. Named attributes may include, for example, item named attributes, category named attributes, spec named attributes, step named attributes and location named attributes. Spec-driven attributes define attributes using a spec and a path in the spec.

Search engine 314 may use, for example, visitor pattern to generate the set of hybrid query instructions. Visitor pattern represents an operation to be performed on the elements of an object structure. A visitor defines a new operation without changing the classes of the objects on which the visitor operates.

Search engine 314 uses visitors to populate data to the abstract syntax tree. In addition, search engine 314 uses visitors to extract query attributes and predicates from the abstract syntax tree. For example, search engine 314 may use the visitor PopulateFromDBVisitor to retrieve data from database 312 and store the retrieved data in the abstract syntax tree. Also, search engine 314 may use, for example, the visitor SQLAttributeVisitor to traverse the abstract syntax tree to collect all attribute data.

Each query attribute path indicates the information for creating the target SQL statement, which includes the table and column type in the relational or indexed product information data model. After analysis of the query, all attributes in the query are identified and mapped to product information data in database 312. These attributes are translated into a SQL based query.

After generating the set of hybrid query instructions, search engine 314 executes the product query search using the set of hybrid query instructions. Search engine 314 may execute the set of hybrid query instructions by, for example, performing a two phase search. In the first phase, search engine 314 employs an SQL based search of the relational product information data within database 312, by utilizing, for example, SQL search processor 320. Search engine 314 performs the relational product information data search first because the product information management domain specific query language adopts the SQL syntax. As a result, search engine 314 searches for indexed object attributes contained within the abstract syntax tree first. If after the first phase of the search serialized or non-indexed object attributes are discovered within the abstract syntax tree, search engine 314 performs the second phase of the search. In the second phase, search engine 314 performs a Java™ based search of the serialized or non-indexed product information data within database 312 by using, for example, Java™ search processor 322.

Below, exemplary product query search statements are shown, along with a description of the target product query search data, for illustration purposes only. As a general example, the product query search statement:
select item
from catalog(‘my catalog’)
where item.category.pk =‘abc’
   returns all items in catalog ‘my catalog’, which are mapped to the category with a primary key ‘abc’. Note that a parenthetical ( ) notation is used to represent function/mapping, such as mapping a name to a catalog; and dot notation is used to retrieve the category mapped to the item (item.cateogry), as well as the primary key of the category (category.pk). All strings are single quoted. As a more specific example, the product query search statement:
select item[‘main spec/desc’]
from catalog(‘main catalog’)
where item[‘main spec/price’] >10
   returns a description of all items in the main catalog, where the price is greater than $10. Note that a bracket [ ] notation is used to represent a spec-driven attribute. In this example, [‘main spec/desc’] and [‘main spec/price’] represent the attributes ‘desc’ and ‘price’ in the spec ‘main spec’, respectively. Also, the product query search statement:
select item
from catalog(‘main catalog’)
where item.category.spec.attribute_path like ‘% cpu %’
   returns all items mapped to a category that uses a spec that has an attribute, which name contains ‘cpu’. Further, the product query search statement:
select item.pk
from catalog(‘main catalog’)
where item.location[‘loc spec/price’] >100
and item.location.hierarchy.name=‘loc tree’
   returns the primary key of all items in ‘main catalog’ that are sold for more than $100 in any location within hierarchy ‘loc tree’.

It should be noted that embodiments of the present invention are not limited to the exemplary product query search statements above. Search engine 314 may generate any hybrid query instructions capable of retrieving any user desired product information query search data located within database 312. Also, it should be noted that as in SQL, each SQL statement returns a table in which the columns are the attributes or objects in the select clause and each row is a match against the where clause.

Embodiments of the present invention expose specs, items, categories, steps, catalogs, and hierarchies as first class objects. First class objects have an identity independent of any other object. This first class identity allows an object to persist when its attributes change. Also, this first class identity allows other objects to claim relationships with the object. A from clause allows direct access to these first class objects and the first class objects may be returned by the select clause.

These first class objects have a fixed number of named attributes and a flexible number of domain specific (spec) driven attributes. A spec-driven attribute is defined in the domain specific language and mappings dictate whether the spec-driven attribute applies to a given item or category. Spec-driven attributes are referred to by using a fully qualified attribute path:‘<spec name>/<attribute path within spec>’ where <attribute path within spec> is the path to the attribute starting from the root node of the spec. With hierarchical specs, depending on the level of nesting of the attribute, the path may contain multiple slashes.

Basically, items and categories behave as hashtables whose keys are attribute paths. This hashtable notation is used in the select, where, and order by clause. In addition to spec-driven attributes, an item also exposes a set of named attributes. These named attributes are accessed using dot notation, such as, for example, item.<named attribute name>.

Named attributes also may be used in the select, where, and order by clauses. For example, the product query search statement:
select item.pk
from catalog(‘main catalog’)
where item.category.pk=‘top category’
and item.category.hierarchy.name=‘product hierarchy’
   returns the primary key of all items in ‘main catalog’ mapped to the category with a primary key ‘top category’. Please note that in the above example, item.category is a category object. Thus, item.category.pk refers to the named attribute primary key of the named attribute category of the item object. Also note that since the primary key is a regular attribute, item.pk refers to the same attribute as item[‘spec/primary key’]. As with the item object, the category object has spec-driven attributes as well as named attributes.

Category named attributes behave the same way as item named attributes. For example, the product query search statement:
select category.child.pk
from category_tree(‘product hierarchy’)
where category.pk=‘top category’
   returns the primary key of all the children of the ‘top category’ of the product hierarchy.

Using embodiments of the present invention, dot and hashtable notations may freely be mixed together. For example, since item.category is itself a category object, the following attributes are valid:
item.category[‘category spec/desc’]
item.category.parent item.category.parent.hierarchy.name
   Furthermore, if ‘main spec/linked attr’ is a linked attribute, item[‘main spec/linked attr’] is an item object, so the following attributes are valid:
item[‘main spec/linked attr’][‘linked spec/desc’]
item[‘main spec/linked attr’].pk
item[‘main spec/linked attr’].category.parent.spec.type

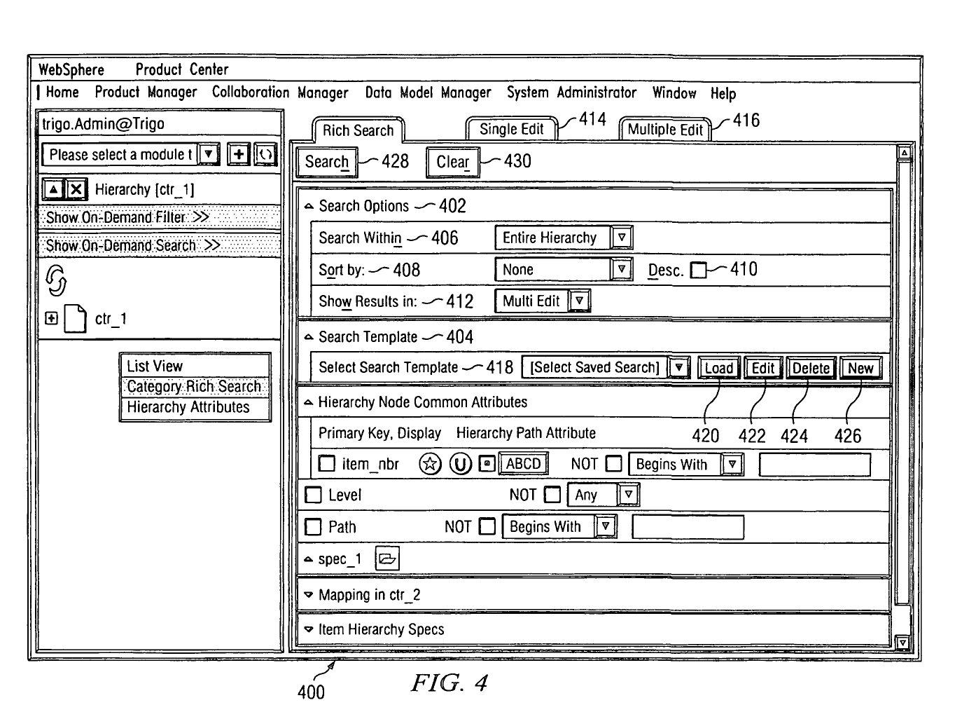

Turning now to FIG. 4, a pictorial illustration of an exemplary window for inputting product information query search criteria is shown in accordance with an embodiment of the present invention. A user may view and interact with query search window 400 in a client device, such as client 306 in FIG. 3. A server, such as server 302 in FIG. 3, uses a product information management system, such as product information management system 310 in FIG. 3, to send query search window 400 to the client device in response to a request for a product information query search. The user may use query search window 400 to perform a query of product information data contained within a database, such as database 312 in FIG. 3.

Query search window 400 may include, for example, search options 402 and search template 404. A user may utilize search options 402 to, for example, specify the scope of the search, how to sort the search results, and where to display the search results. The scope of the search may be defined by “search within” 406. A user may employ “search within” 406 to run the search within a given selection, such as in this particular example, the entire data hierarchy. “Search within” 406 may present selections, for example, in a drop-down menu. Another given selection for “search within” 406 drop-down menu may be, for example, any saved selection, such as a search within a pre-saved selection of hierarchy nodes.

A user may use “sort by” 408 to determine how the search engine, such as search engine 314 in FIG. 3, sorts the search results. For example, the search engine may sort the search results by hierarchy level, which is the node level in the data hierarchy, hierarchy path, or other attributes. Again, selections for “sort by” 408 may be presented in a drop-down menu. The default setting for listing search results is ascending order. However, if a user places a checkmark within “descending” checkbox 410 by using, for example, a “mouse click,” then the search engine lists search results in descending order.

A user may utilize show “results in” 412 to indicate where the search engine displays the search results. Once again, selections for show “results in” 412 may be presented in a drop-down menu. Given selections for show “results in” 412 may be, for example, single edit, multiple edit, or based on number of matches. By selecting single edit or multiple edit, the search engine displays the search results on the single edit or multiple edit tabbed page, such as “single edit” tabbed page 414 or “multiple edit” tabbed page 416, respectively, regardless of whether there are one or more entries matching the query search criteria. On the other hand, by selecting the based on number of matches option, the search engine shows the search result on the single edit tabbed page if there is only one matched entry or on the multiple edit tabbed page if there are two or more matched entries. In this particular example, the user selected the multiple edit option in the drop-down menu.

A user may employ “search template” 404 to pre-define a product information query search template with a collection of specs and/or attributes. The user uses “select search template” 418 to choose a previously saved template from a list of saved templates presented in, for example, a drop-down menu. Subsequent to selecting a previously saved product information query search template from the drop-down menu, the user mouse clicks on “load” button 420 to load the previously saved product information query search template data.

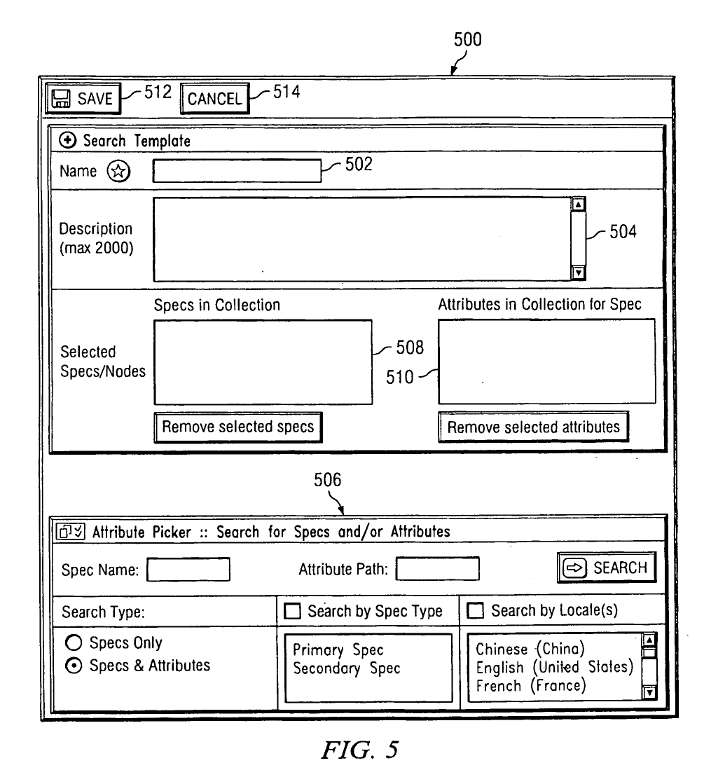

After selecting a previously saved query search template, the user may desire to edit the selected query search template. Consequently, the user may mouse click on “edit” button 422. Subsequent to mouse clicking “edit” button 422, a new search template window, such as new search template window 500 in FIG. 5 discussed below, appears in the client device for the user to edit the previously saved query search template. In addition, the user may wish to delete the selected query search template. As a result, the user may mouse click on “delete” button 424 to remove the selected query search template from the drop-down menu list.

If the user desires to create a new product information query search template, the user may mouse click on “new” button 426. After mouse clicking “new” button 426, the new search template window appears in the client device for the user to create a new product information query search template. Subsequent to inputting all the desired product information query search criteria within query search window 400, the user may mouse click on “search” button 428 to start the product information search query process. Alternatively, the user may mouse click on “clear” button 430 to clear all inputs within query search window 400.

With reference now to FIG. 5, a pictorial illustration of an exemplary window for creating a product information query search template is depicted in accordance with an embodiment of the present invention. A user may view and interact with new product information search template window 500 in a client device, such as client 306 in FIG. 3. The user utilizes new product information search query window 500 to create a new product information query search template or edit a previously saved product information query search template after the user mouse clicks on a new button or edit button within a search template area of a product information query search window. For example, a user mouse clicks on “edit” button 422 or “new” button 426 within search template 404 of query search window 400 in FIG. 4 in order to create a new product information query search template or edit a previously saved product information query search template.

New product information search template window 500 may include, for example, template “name” textbox 502, template “description” textbox 504, and template “attribute picker” 506. A user utilizes “attribute picker” 506 to list specs and/or attributes within “specs in collection” textbox 508 and “attributes in collection for specs” textbox 510, respectively.

After inputting all necessary criteria to create the new product information query search template or to edit a previously saved product information query search template, the user may mouse click on “save” button 512 to save all inputs within new product information search template window 500. Alternatively, the user may mouse click “cancel” button 514 to cancel all inputs within new product information search template window 500.

Referring now to FIG. 6, an exemplary illustration of an object model in a product information management domain specific query language is shown in accordance with an embodiment of the present invention. The set of hybrid query instructions generated by the search engine, such as search engine 314 in FIG. 3, combine both structured query language and object-oriented query language. Consequently, object model in product information management domain specific query language 600 is the object-oriented query language model implemented in the structured query language model by the search engine to generate the set of hybrid query instructions. In this illustrative example, the objects defined in the product information management domain specific query language are item, category, catalog, hierarchy, location, spec, and step.

Object model in product information management domain specific query language 600 shows a type name with an uppercase first letter and an object name with a lowercase first letter. For example, ‘Item’ is a type name and ‘item’ is an object name. Each box within object model in product information management domain specific query language 600 represents an object. Each object box contains an object name and a type name. The object box lists all available non-object attributes.

Spec-driven attributes 602 for item relationship and item link are of the object type Item and behave as item:Item 604. One object box may link to another object box where the linked object box is the object attribute of the linking object box. For example, object box 604 may link to object box 606 where linked object box 606 is the object attribute of the linking object box 604. Location, parent and child object boxes 608 are of the object type Category and behave as category:Category 610. Spec-driven attribute 612 for type names Item and Category are of non-object types, whereas, item link and item relationship spec-driven attributes 602 are object types. Item link, item relationship, and item are types of Item.

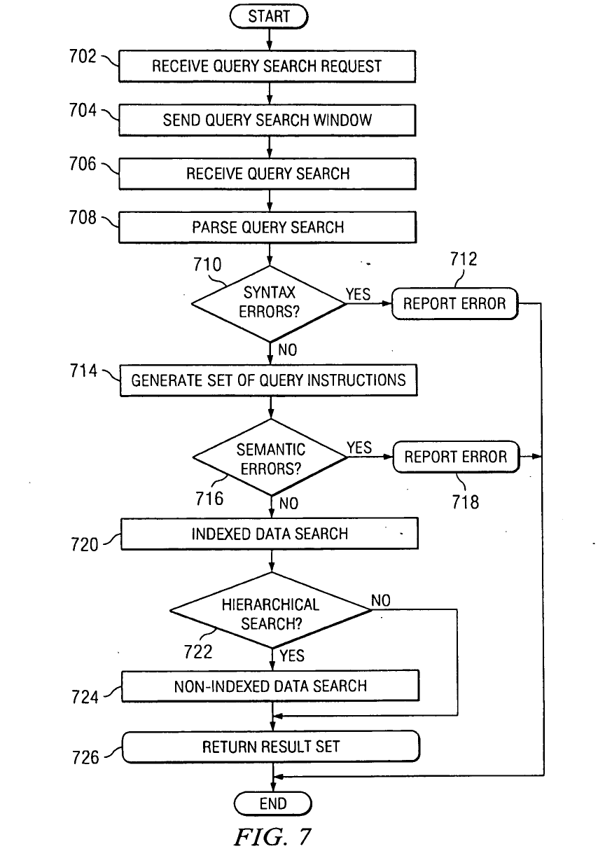

Turning now to FIG. 7, a flowchart illustrating an exemplary process for a server device to retrieve product information data is depicted in accordance with an embodiment of the present invention. The process depicted in FIG. 7 may be implemented in a server device, such as server 302 in FIG. 3. More specifically, the process may be implemented within a search engine, such as search engine 314 in FIG. 3, which is contained within the server device.

The process begins when the server device receives a request for a product information search query from a client device, such as client 306 in FIG. 3 (step 702). In response to receiving the product information search query request in step 702, the server device uses a product information management system, such as product information management system 310 in FIG. 3, to send a product information query search window, such as query search window 400 in FIG. 4, to the client device (step 704). A user using the client device inputs the desired product information query search criteria within the query search window and sends the query search window back to the product information management system.

The product information management system receives the product query search string contained within the query search window (step 706). After receiving the product query search string in step 706, the product information management system employs a search engine, such as search engine 314 in FIG. 3, to parse the product query search string (step 708). The search engine may utilize, for example, a syntax parser, such as syntax parser 316 in FIG. 3 to parse the product query search string.

In addition to parsing the product query search string in step 708, the syntax parser makes a determination as to whether the product query search string contains syntax errors (step 710). If the product query search string does contain syntax errors, yes output of step 710, then the product information management system sends an error report to the client device (step 712) and the process terminates thereafter. If the product query search string does not contain syntax errors, no output of step 710, then the search engine generates a set of hybrid query instructions from the parsed product query search string (step 714).

Hybrid query instruction generation includes, for example, data population of the abstract syntax tree, attribute analysis, and generation of the hybrid query instruction. After analysis of the product query search, the search engine generates the hybrid query instruction by identifying all object attributes in the abstract syntax tree and mapping the identified object attributes to the product information data contained in a database, such as, for example, database 312 in FIG. 3. The hybrid query instructions exist in the form of the abstract syntax tree and/or sub-trees. Subsequent to hybrid query instruction generation in step 714, the search engine makes a determination whether the hybrid query instruction set contains semantic errors (step 716). In other words, the search engine makes a determination whether the search engine can execute the set of hybrid query instructions. The search engine may utilize a semantic checker, such as semantic checker 318 in FIG. 3, to perform the semantic check. The search engine translates these object attributes defined in the product information management domain specific query language into regular SQL statements to query through a standard database management system, such as DB2®. For example, the product information management domain specific query:
select item
from catalog(‘prod ctg’)
where item.pk=‘abc’
   is translated to the regular SQL statement:
select itml.itm_id
from itm itml
where itml.itm_container_id=<id for prod ctg> itml.itm_primary_key=‘abc’The product information management domain specific query above is the root node in the abstract syntax tree. From the query root node the abstract syntax tree branches out to a “select clause” node and a “from clause” node. The select clause is used to define the data to search for, the from clause is used to define where the data is stored, such as, for example, in a catalog or a hierarchy, and the where clause is used to define the search conditions. The product information management domain specific query also may, for example, have an “order by clause” to sort the search result data. From the select clause node the abstract syntax tree may, for example, branch out to an “attribute 1” node and an “attribute 2” node. From the attribute 1 node the abstract syntax tree may, for example, branch out to an “item” node and a “spec-driven” or “spec-named” attribute terminal node, which may be, for example, an indexed attribute. From the attribute 2 node the abstract syntax tree may, for example branch out to an “item” node and a “spec-driven” or “spec-named” attribute node, which may be, for example, a non-indexed attribute. In addition, the search engine may call internal Java functions to perform other query instructions that may not be executed using SQL. For example, the product information management domain specific query:
select item[‘location:spec/price’]
from catalog(‘prod ctg’)
   is querying the semi-structured hierarchical data. The search engine performs additional query functions using the non-indexed serialized search component.

If the hybrid query instruction set contains semantic errors, yes output of step 716, then the product information management system sends an error report to the client device (step 718) and the process terminates thereafter. If the hybrid query instruction set does not contain semantic errors, no output of step 716, then the search engine executes a relational indexed product information data search of data residing in a database, such as, database 312 in FIG. 3 using the generated hybrid query instruction set (step 720). The search engine may use, for example, an SQL search processor, such as SQL search processor 320 in FIG. 3, to execute the relational indexed product information data search of the database.

After executing the indexed product information data search in step 720, the search engine makes a determination whether a hierarchical non-indexed product information data search is required (step 722). If the search engine discovered a reference to non-indexed product information data during the indexed product information data search in step 720, then a hierarchical non-indexed product information data search is required. If the search engine did not discover a reference to non-indexed product information data during the indexed product information data search in step 720, then a hierarchical non-indexed product information data search is not required.

If a hierarchical non-indexed product information data search is required, yes output of step 722, then the search engine executes a hierarchical non-indexed product information data search using the generated hybrid query instruction set (step 724). The search engine may utilize, for example, a Java™ search processor, such as Java™ search processor 322 in FIG. 3, to execute the hierarchical non-indexed product information data search. Subsequent to executing the hierarchical non-indexed product information data search in step 724, the process proceeds to step 726. If a hierarchical non-indexed product information data search is not required, no output of step 722, then the search engine returns a result set of the product information query search to the client device (step 726). The process terminates thereafter.

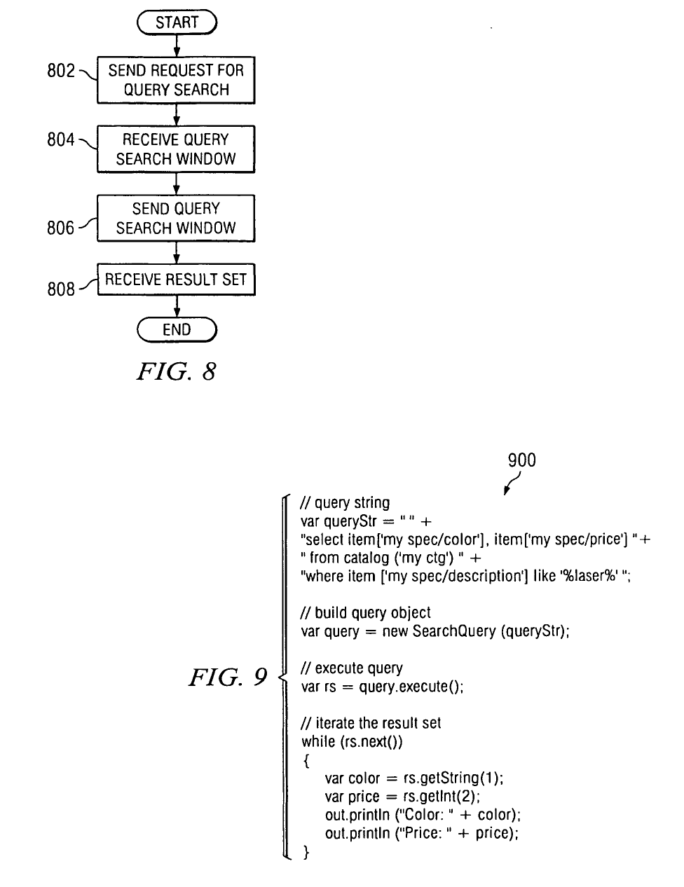

With reference now to FIG. 8, a flowchart illustrating an exemplary process for a client device to request product information data retrieval is shown in accordance with an embodiment of the present invention. The process depicted in FIG. 8 may be implemented in a client device, such as client 306 in FIG. 3.

The process begins when a user using the client device sends a request for a product information query search to a server device, such as server 302 in FIG. 3 (step 802). The client device receives a product information query search window, such as query search window 400 in FIG. 4, in response to the product information query search request sent in step 802, from a product information management system, such as product information management system 310 in FIG. 3, which resides in the server device (step 804). The user using the client device inputs the desired information for a particular product query search into the query search window.

After inputting the desired information for the product query search, the user utilizing the client device sends the product information query search window back to the product information management system for processing (step 806). The product information management system uses a search engine, such as search engine 314 in FIG. 3, to execute the product information query search. Subsequent to executing the product information query search, the search engine sends a result set for the product information query search to the client device. The client device receives the result set from the search engine (step 808). The process terminates thereafter.

Referring now to FIG. 9, an exemplary query script operation is depicted in accordance with an embodiment of the present invention. An application developer may locate the query script operation for retrieving product information query search data within a search engine, such as search engine 312 in FIG. 3. Query script operation 900 is only meant as an exemplary illustration of a query script operation, which may be utilized by embodiments of the present invention to retrieve product information query search data. It should be noted that embodiments of the present invention are not restricted to the use of query script operation 900. Any query script operation may be employed by embodiments of the present invention that is capable of retrieving product information query search data.

Thus, embodiments of the present invention provide a computer implemented method, apparatus, and computer usable program code for retrieving product information query search data. The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer program product for searching for data in a database, the computer program product comprising:
a computer usable medium having computer usable program code embodied therein, the computer usable medium comprising:
computer usable program code for receiving a query search in a query language using objects, wherein the query search includes a number of objects having attributes;
computer usable program code for generating a set of hybrid query instructions using the number of objects having attributes for searching relational and hierarchical data in the database; and
computer usable program code, responsive to generating the set of hybrid query instructions recognized by the database for searching data, for executing the set of hybrid instructions to obtain a result from the database.

2. The computer program product of claim 1, wherein the computer usable program code, responsive to generating the set of hybrid query instructions recognized by the database for searching data, for executing the set of hybrid instructions to obtain a result from the database comprises:
computer usable program code for searching indexed data in the database using the set of hybrid instructions to retrieve the data; and
computer usable program code for searching non-indexed data in the database using the set of hybrid instructions to retrieve the data.

3. The computer program product of claim 1, wherein each hybrid instruction in the set of hybrid instructions comprises a query to indexed data or a query to non-indexed data.

4. The computer program product of claim 1, wherein the computer usable program code for generating a set of hybrid query instructions using the number of objects having attributes for searching relational and hierarchical data in the database comprises:
computer usable program code for creating an abstract syntax tree from the objects in the query search
computer usable program code for mapping the attributes for the number of objects in the abstract syntax tree to data in the database to form a mapped abstract syntax tree; and
computer usable program code for creating a set of queries using the mapped abstract syntax tree to search at least one of indexed data and non-indexed data in the database, wherein the queries are recognized by the database.

5. A computer implemented method for retrieving product information data, the computer implemented method comprising:
responsive to receiving a query search in a product information management domain specific query language to retrieve product information data, generating a set of hybrid query instructions using one or more product information management system objects defined by the product information management domain specific query language, wherein the one or more product information management system objects contain attributes within the product information management domain specific query language for searching relational and hierarchical product information data;
responsive to generating the set of hybrid query instructions, querying indexed product information data within a database using the set of hybrid query instructions to retrieve the product information data; and
responsive to retrieving the product information data, returning a result set.

6. The computer implemented method of claim 5, further comprising:
responsive to generating the set of hybrid query instructions, searching non-indexed product information data within the database to retrieve the product information data if non-indexed product information data is discovered after the indexed product information data query is performed.

7. The computer implemented method of claim 6, further comprising:
parsing the query search to form a parsed query search;
creating an abstract syntax tree from the parsed query search;
populating the abstract syntax tree with attributes from the one or more product information management system objects; and
mapping the attributes in the abstract syntax tree to the product information data to generate the set of hybrid query instructions.

8. The computer implemented method of claim 5, wherein the product information management domain specific query language is a hybrid query language that includes structured query language and object-oriented query language.

9. The computer implemented method of claim 8, wherein the structured query language is used to search the indexed product information data, and wherein the object-oriented query language is used to search the non-indexed product information data.

10. The computer implemented method of claim 7, wherein the generating, querying, returning, parsing, creating, populating, and mapping steps are executed by a search engine.

11. The computer implemented method of claim 10, wherein the search engine uses a query script operation to perform the generating, querying, and returning steps.

12. The computer implemented method of claim 10, wherein the search engine creates the abstract syntax tree.

13. The computer implemented method of claim 10, wherein the search engine uses a syntax parser to parse the query search to create the abstract syntax tree.

14. The computer implemented method of claim 13, wherein the syntax parser determines if the query search contains syntax errors, and wherein the search engine sends an error report if the query search contains syntax errors.

15. The computer implemented method of claim 10, wherein the search engine resides in a product information management system.

16. The computer implemented method of claim 6, wherein the indexed product information data resides in a database, and wherein the non-indexed product information data resides in a memory.

17. The computer implemented method of claim 5, wherein the set of hybrid query instructions includes at least one of a dot notation or a hashtable notation.

18. A computer program product for retrieving product information data, the computer program product comprising:
a computer usable medium having computer usable program code embodied therein, the computer usable medium comprising:
computer usable program code configured to generate a set of hybrid query instructions using one or more product information management system objects defined by the product information management domain specific query language, wherein the one or more product information management system objects contain attributes within the product information management domain specific query language for searching relational and hierarchical product information data in response to receiving a query search to retrieve product information data;
computer usable program code configured to query indexed product information data within a database using the set of hybrid query instructions to retrieve the product information data in response to generating the set of hybrid query instructions; and
computer usable program code configured to return a result set in response to retrieving the product information data.

19. The computer program product of claim 18, further comprising:
computer usable program code configured to search non-indexed product information data within the database to retrieve the product information data if non-indexed product information data is discovered after the indexed product information data query is performed in response to generating the set of hybrid query instructions.

20. The computer program product of claim 19, further comprising:
computer usable program code configured to parse the query search to form a parsed query search;
computer usable program code configured to create an abstract syntax tree from the parsed query search;
computer usable program code configured to populate the abstract syntax tree with attributes from the one or more product information management system objects; and
computer usable program code configured to map the attributes in the abstract syntax tree to the product information data to generate the set of hybrid query instructions.
